(19) United States
(12) Patent Application Publication
(10) Pub. No.: US 2010/0297589 A1
(43) Pub. Date: Nov. 25, 2010

(54) DEVICE ARRANGED FOR ILLUMINATE AN AREA

(75) Inventor: Johan Ruud, Huskvarna (SE)

Correspondence Address: VENABLE LLP, P.O. BOX 34385, WASHINGTON, DC, 20043-9998, US

(73) Assignee: SAAB AB, Linköping (SE)

(21) Appl. No.: 12/377,958

(22) PCT Filed: Aug. 8, 2007
(86) PCT No.: PCT/EP2007/058221

§ 371 Date: Aug. 5, 2010

(30) Foreign Application Priority Data
Aug. 18, 2006 (EP) 06119165.6

(51) Int. Cl. F41G 3/26; H04B 10/04; G09B 9/08

(52) U.S. Cl. 434/21; 398/188; 434/30

(57) ABSTRACT

A device arranged to illuminate an area. The device includes a light source arranged to transmit a light lobe coded with information, and having a predetermined solid angle defining the width of the lobe. The light lobe is expandable/compressible between a first mode in which the light lobe has a first predetermined solid angle and a second mode in which the light lobe has a second predetermined solid angle. The light lobe is arranged to carry first information in the first mode and second information in the second mode.

### TECHNICAL AREA

The present invention relates to a device arranged to illuminate an area comprising a light source arranged to transmit a light lobe said light lobe being coded with information and having a predetermined solid angle defining the width of the light lobe, according to the preamble of claim 1.

### BACKGROUND OF THE INVENTION

When, in the same manner as during actual firing, a weapon is aimed at a target during fire simulation, it is necessary to determine the extent to which a live round fired using the alignment that the weapon has during the simulated firing would or would not hit the target. It is also desirable to be able to determine the hit location and the effect of the hit.

There are at least two different principles of operation for devices of this type. The first is a so-called one-way system transmitting lobe-shaped light pulses along a simulation axis. When operating in accordance with this principle, the target system is arranged to determine hit location and hit effect. The second type is a so-called two-way system, in which in one embodiment receivers of the light pulses at the target are provided with reflectors, so that the transmitting device receives such reflected light and changes the information content of the light transmitted in dependence thereupon. When operating in accordance with this principle both the transmitting system and target system can be able to determine the hit location and the hit effect.

U.S. Pat. No. 4,218,834 describes a weapon simulation method in accordance with the second type, based on a laser transmitter disposed on or near the weapon. The laser transmitter is arranged to emit laser radiation in the direction in which the weapon is pointed, and the targets are equipped with reflectors arranged so as to reflect the laser radiation back toward the weapon. Means disposed at the weapon to generate a projectile trajectory signal are started simultaneous with the firing of a simulated projectile. The projectile trajectory signal reproduces the continuously changing position of an imagined real projectile fired at the same moment as the simulated projectile, and contains a distance value calculated with reference to the weapon, plus calculated aiming values referenced to a predetermined axis pointing from the weapon in the direction of the projectile trajectory.

The laser radiation is caused to execute a sweeping movement in order to scan an area in front of the weapon, whereupon the radiation that is reflected from target reflectors located in front of the weapon is received. Signals are generated from the received radiation that contain a distance value based on a measurement of the time between the transmission and reception of the reflected radiation, which value is comparable with the calculated distance value, and aiming values corresponding to the current radiation, which aiming values are comparable with the calculated aiming values. The measured values are compared with the comparable calculated values in order to determine whether the real projectile would have hit the target.

U.S. Pat. No. B1 6,386,879 describes a weapon simulation system based on similar principles, but here the target is arranged so as to receive and assess received radiation.

### DESCRIPTION OF THE INVENTION

One object of the present invention is to provide a way of illuminating an area with a laser source without the need for mechanics, or with very simple mechanics, for providing a sweep in the area.

This object is achieved by a device arranged to illuminate an area and comprising a light source arranged to transmit at least one light lobe said light lobe being coded with information and having a predetermined solid angle defining the width of the light lobe. The device is characterized in that the light lobe is expandable/compressible between a first mode in which the light lobe has a first predetermined solid angle and a second mode in which the light lobe has a second predetermined solid angle and in that the light lobe is arranged to carry first information in the first mode and second information in the second mode.

In summary, the device according to the invention offers numerous advantages.

The expansion/compression of the solid angle of the light lobe can be generated with simple mechanics, for example by zoom optics (lens movement along the optical axis), or without mechanics for example by electrically changing the focal length of an electro-optical or liquid lens.

In the systems of both U.S. Pat. No. 4,218,834 and U.S. Pat. No. B1 6,386,879, the scanning procedures are performed in Cartesian coordinate systems. The mechanics for the Cartesian like scanning movements along the X and Y axis are complex, expensive and bulky. Due to the fact that the present invention instead can use the output power or simple electro-optical or mechanical zoom optics, as it scans in a polar coordinate system, the overall size of the laser unit can be reduced significantly.

Another advantage of the device according the invention is that it is capable of providing different light-carried information to different parts of a larger area without the use of a complex mechanism for continuously deflecting the light beam over said area. This is for example very useful in laser based shooting simulators usually provided with complicated mechanics for deflecting the light beam such that it covers the entire area.

In accordance with one embodiment of the invention, the light source is arranged to transmit the light lobe with a number of selectable solid angles within an interval between the first predetermined solid angle and the second predetermined solid angle, each selectable solid angle being associated to corresponding information. The information is for example related to the current solid angle.

In accordance with another embodiment of the invention, the light source is arranged to substantially continuously expand/compress the light lobe between the first and second solid angle and the light lobe is continuously coded with information related to the current solid angle.

It is not relevant to the present invention how the light lobe is shaped. It can for example be circular-shaped or shaped as a sector of a circle. Further, it can either be hollow or solid.

The light lobe(s) emitted is for example generated by laser. The laser can be working in the IR range or another frequency range. In accordance with one embodiment of the invention, the light source comprises one or more laser transmitters arranged to provide at least one laser lobe.

In one embodiment of the invention, an optical arrangement is arranged in the beam path after the light source. The optical arrangement is arranged to form a selected solid angle among at least the first solid angle and the second solid angle. Alternatively, the output power of the light source is adaptive so as to expand/compress the light lobe between the first predetermined solid angle and the second predetermined solid angle. The output power of the light source could also be adaptive as a function of the solid angle so as to provide different ranges for different solid angles, so that a specified range is associated to each solid angle.

In another embodiment of the invention, the device comprises means for forming the light lobe so as to provide an essentially constant lobe width substantially along the entire range of the light lobe.

In accordance with one application mode, the device is included in a shooting simulator, wherein the light lobe is used for simulating live ammunition. The shooting simulator is for example mounted on a live weapon or a replica of a live weapon. The weapon can, for instance, be person-borne or vehicle-borne. In yet another embodiment the weapon is virtual, and its entire existence is simulated by a fire simulation system at an observer/forward observer, or a command and control system.

The device according to the invention allows a simple shooting simulator to operate to cover both a kill area and a near miss area, for example, by using two predetermined solid angles. Existing MILES system generates a larger near miss area by boosting up the laser power primarily to extend the simulation range. However, in order to achieve a realistic near miss function, it is the solid angle that should be expanded/compressed with precision. Accordingly, in a simple version of the shooting simulator, the second solid angle is larger than the first solid angle and the first information contains hit information and the second information contains near miss information, for example according to the MILES standard.

The invention further relates to a system comprising a device as described above, said device being arranged to illuminate an area and comprising a light source arranged to transmit at least one light lobe, and one or more objects present within said area. Each object is provided with a target system arranged to detect said light lobe. The light source is in one example arranged to substantially continuously expand/compress the light lobe, the light lobe is then continuously coded with information related to the current solid angle and said objects are arranged to determine a centre of said light lobe.

In accordance with one embodiment of the system, each target system comprises at least one detector arranged to detect incident light and to feed the information coded on the detected light to a processing unit of the target system. The processing unit is then arranged to determine an angular distance to the centre of the lobe based on the angle information coded in the detected lobes. In a simple shooting simulation it is the determined distance to the centre of the lobe that determines the impact level on the target.

In accordance with another embodiment of the system, each target system comprises at least two detectors arranged in a known relation to each other. Each detector is arranged to detect incident light and to feed the information coded on the detected light to a processing unit of the target system. The processing unit is arranged to determine an angular distance and direction to the centre of the lobe based on the angle information coded in the detected lobes and the known relation between the detectors. Depending on the shape of the light lobe, the direction to the centre might be ambiguous. This ambiguity vanishes if the target system comprises at least three detectors.

The present invention provides high precision simulation where the precision is set by the target system. The same shooting simulator can be used against a one detector target system and yield a miss, near miss or kill, or be used against a two or three detector target to yield a high accuracy hit position.

Also, if the distance between a shooting system provided with the illuminating device and a target system, i,e, an object arranged to detect incident light, is known, it is possible to calculate the absolute distance to the centre of the light lobe, i.e., the simulated hit point.

The distance between the shooting system and the target can be determined in various ways, for example by letting the target systems calculate the distance to the shooting systems and determining their own GPS position. The shooting systems GPS position can for example be transferred to the target system via the coded light lobe or it could already be known to the target systems through an information radio network. Many shooting systems have an embedded range finding system and the measured range could in that case be transmitted to the target system via the coded light. In a case wherein the light lobe is hollow with a known circular angle thickness and the angular sweep speed is known it is possible to determine the distance by measuring the time a detector is illuminated in a sweep sequence. How to determine the distance between the shooting system and target system is not crucial for the invention and is therefore not further developed in this application.

Alignment of the shooting system can be done using the light source to continuously expand/compress the light lobe. The information coded onto the light lobe contains information corresponding to the current solid angle. If a detector at a known distance from the shooting system detects the light and feeds the coded information to a processing unit, the processing unit can determine how well the shooting system is aligned.

In one alignment embodiment a shooter aims at the alignment target with an actual sight or aiming device of a weapon. The alignment target comprises at least two, preferably three, laser detectors and a processing unit connected to means for providing visual feedback to the shooter. In the alignment procedure, the shooting system starts to expand and compress the light lobe, as discussed above. If the processing unit in the target system determines that the aim point of the shooting system is within certain acceptable limits, the processing unit signals OK to the shooter. Otherwise, more or less sophisticated information systems can be used to inform the shooter of the specific alignment need.

The device can also be used in other applications such as IFF systems (Identification Friend Foe), reflector searching systems, missile navigation systems and other communicating systems where it is of interest to determine an accurate distance to a centre of an axis.

### BRIEF DESCRIPTION OF FIGURES

FIG. 1 shows an example of a transmitting unit in accordance with one example of the present invention.

FIG. 2 shows a first example of the optics in the transmitting unit in FIG. 1

FIG. 3 shows a second example of the optics in the transmitting unit in FIG. 1

FIG. 4 illustrates calculations for determining the centre of a light lobe from the transmitting unit in FIG. 1.

FIG. 5 shows a first example of a target system illuminated with the transmitting unit in FIG. 1.

FIG. 6 shows a second example of a target system illuminated with the transmitting unit in FIG. 1.

FIG. 7 illustrates graphically how the centre of a light lobe from the transmitting unit in FIG. 1 is calculated.

FIG. 8 shows a block diagram of the target system in FIG. 5 or 6.

FIG. 9 shows a block diagram over the transmitting unit in FIG. 1 implemented in a shooting simulator system according to one example of the invention.

### PREFERRED EMBODIMENTS

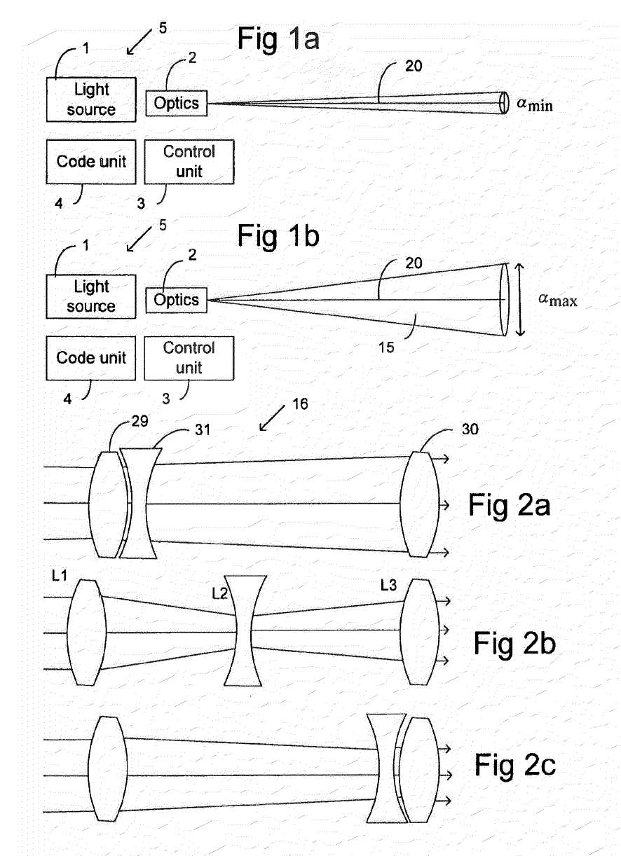

In FIG. 1, a transmitting system 5 comprises a light source 1 and optics 2 mounted in the beam path of a light lobe from the light source 1. The optics 2 are arranged to form a selected solid angle of an outgoing light lobe 15. The light source 1 can for example include one or more laser transmitters each arranged to provide a laser lobe. The laser transmitters can be laser diodes or laser transmitters of other types. The optics 2 are controllable by means of a control unit 3 such that the solid angle of one or more light lobes 15 emitted from the light source 1 can be increased or decreased between a min selectable solid angle αₘᵢₙ (FIG. 1a) and a max selectable solid angle αₘₐₓ (FIG. 1b). In one example αₘᵢₙ=0.5 mrad and αₘₐₓ=20 mrad. In FIG. 1, a center axis 20 of the light lobe 15 has reference number 20. The values for αₘᵢₙ and αₘₐₓ are chosen in line with in which application the transmitting system is to be used but the value for αₘₐₓ should be chosen such that it is secured that the light lobe 15 illuminates the whole area that is to be illuminated. As the optics 2 are controlled such that the solid angle is increasing/decreasing within the range αₘᵢₙ-αₘₐₓ, the outgoing light lobe 15 projected on a surface in front of the light source is increasing or decreasing. Thus, the projected lobe is altered radially, and therefore the light lobe is hereinafter explained to perform a radial sweep. The radial sweep is performed either continuously or in discrete steps. A code unit 4 is arranged to form coded information related to the current solid angle of the light beam and other information, which will be described below. The coded information is encoded into the light beam under control from the control unit 3.

In FIG. 2, the optics comprises a mechanical zoom 16. The mechanical zoom comprises a first concave lens 29 and a second concave lens 30 arranged in fixed relation to each other in a beam path. A convex lens 31 is arranged between the first and second lens. The convex lens 31 is movable in the beam path between the first 29 and second 30 concave lens, wherein the position of the convex lens determines the width of the outputted light lobe 15. In FIG. 2a, the convex lens 31 is positioned adjacent the first concave lens 29. With the convex lens 31 in this position, the outputted light lobe 15 has its maximum width. In FIG. 2c, the convex lens 31 is positioned adjacent the second concave lens. With the convex lens 31 in this position, the outputted light lobe 15 has its minimum width. In FIG. 2b, the convex lens 31 is positioned at an equal distance from the first 29 and the second 30 concave lens. Note that FIG. 2 only describes the principles of a mechanical zoom. In practice, in order to provide high accuracy, the mechanical zoom usually comprises an arrangement containing a plurality of lenses.

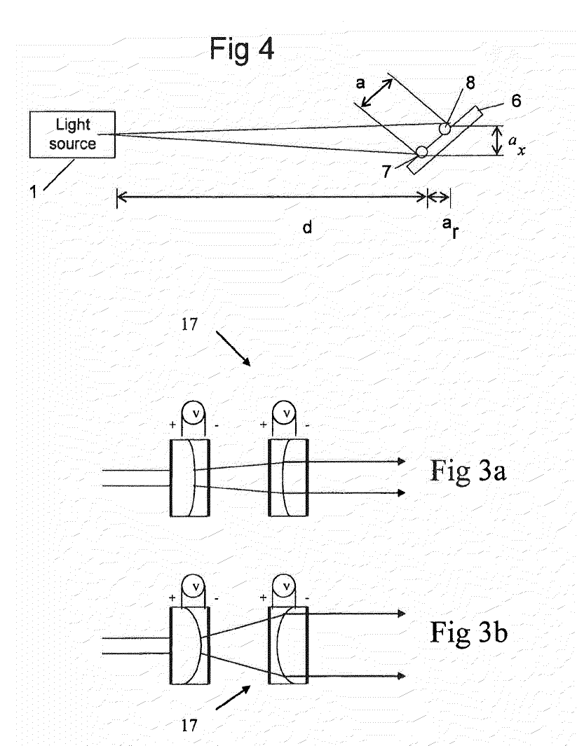

In FIG. 3, the optics 2 comprises a non-mechanical zoom 17. The expanding/compressing function can be achieved through for example a electro-optical nematic or ferroelectric liquid crystals lens system that changes the light lobe to the desired solid angle. In one example, the liquid lens comprises isodensity liquids, one is an insulator while the other is a conductor. By varying an applied voltage, the curvature of the liquid-liquid interface is changed. This results in a change in the focal length of the lens. The optical zoom in FIG. 3 consists of two of these lenses in series. The voltage applied on each lens is adapted to generate a comparatively smaller width in FIG. 3a and a comparatively larger width in FIG. 3b.

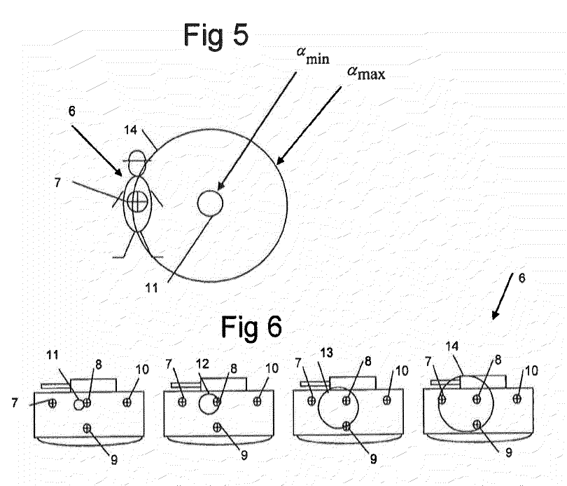

In FIG. 5, a target system 6 is provided with one detector 7. In the shown embodiment the target system is a person such as a soldier, but it can also for example be a tank. In a first phase, wherein the light lobe pointed at the target system has a solid angle αₘᵢₙ, the light lobe covers an initial area 11 of the target system not covered by the detector 7 and accordingly, the detector does not detect the light. As the solid angle of the laser lobe increases, the radial sweep finally reaches a maximum solid angle αₘₐₓ, wherein the light lobe covers a maximum area 14 of the target system and is incident upon the detector 7. The detected light is decoded in a decoding unit 18 (FIG. 8) and the decoded information is fed to a processing unit 19 which is arranged to time mark the received information with time data t₁.

In one application, the information encoded in the light lobe 15 relates to the current solid angle. The target system is then in one example arranged to determine the centre 20 of the laser lobe 15 based on the solid angle information encoded in the laser lobe. The detector 7 which was radiated with the laser lobe is associated to a first solid angle α₁ included in the information carried by the light lobe at the time t₁ when the light first was incident on the detector. Further, the physical position of the detector on the target is known to the target system. As the solid angle α₁ at the detector 7 is known and as the physical position of the detector on the target is known, is it possible to determine if the target was hit or not.

In FIG. 6, a target system 6 is provided with four detectors 7, 8, 9, 10. In a first phase, wherein the light lobe pointed at the target system has a solid angle αₘᵢₙ, the light lobe covers an initial area 11 of the target system not covered by any detector and accordingly none of the detectors detects the light. As the solid angle of the laser lobe increases, the radial sweep reaches a second phase, wherein the light lobe covers a first area 12 of the target system and is incident upon a first one 8 of the detectors. The detected light is decoded in a decoding unit 18 (FIG. 8) and the decoded information is fed to a processing unit 19 which is arranged to time mark the received information with time data t₁. In a third phase, the light lobe has expanded to cover a second area 13 and such that it is incident also on a second one 9 of the detectors, said received coded information being decoded by the decoding unit 18 and fed to the processing unit 19 wherein the information is time marked with time data t₂. In a fourth phase, the light lobe has expanded further to cover a third area 14 and such that it is incident also on a third one 7 of the detectors, said detected coded information being decoded and fed to the processing unit 19 wherein the information is time marked with time data t₃.

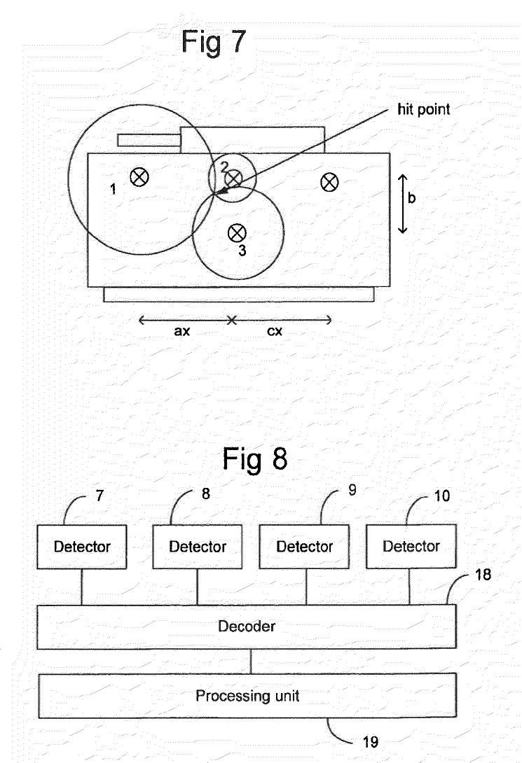

An application is described in relation to FIG. 7 and FIG. 4, wherein the information encoded in the light lobe relates to the current solid angle and the target system is arranged to determine the centre 20 of the laser lobe 15 based on the solid angle information encoded in the laser lobe. The first detector 8, which was first radiated with the laser lobe is associated to a first solid angle α₁ included in the information carried by the light lobe at the time t₁ when the light first was incident on the first detector. The second detector 9 is associated to a second solid angle α₂ included in the information carried by the light lobe at the time t₂ when the light first was incident on the second detector. The third detector 7 is associated to a third solid angle α₃ included in the information carried by the light lobe at the time t₃ when the light first was incident on the third detector. In FIG. 7, the distance between the first and third detector is indicated with letter aₓ, the distance between the first and second detector is indicated with letter b and the distance between the first 8 and fourth detector 10 is indicated with letter cₓ.

The processing unit 19 of the target system is arranged to determine how the target system is oriented in relation the incident light lobe. The processing unit 19 has information about the sweeping velocity of the radial sweep and about the relations and distances between the detectors.

In a simple example, we assume that the target object is not expected to rotate around an axis defined by the tight beam and in a plane perpendicular to the light beam. This means that the first 8 and third 7 detectors arranged in a horizontal plane in FIG. 7 are assumed to always being arranged horizontally in relation to each other and the first 8 and second 9 detectors arranged vertically in relation to each other in FIG. 7 are assumed to always being arranged vertically in relation to each other.

However, a target object on which the target system 6 is mounted is assumed to rotate in relation to the transmitting system such that the target system is not always positioned in the plane perpendicular to the light beam. In fact, the detectors are more likely to be located at different distances from the transmitting system along the beam path than in the same plane.

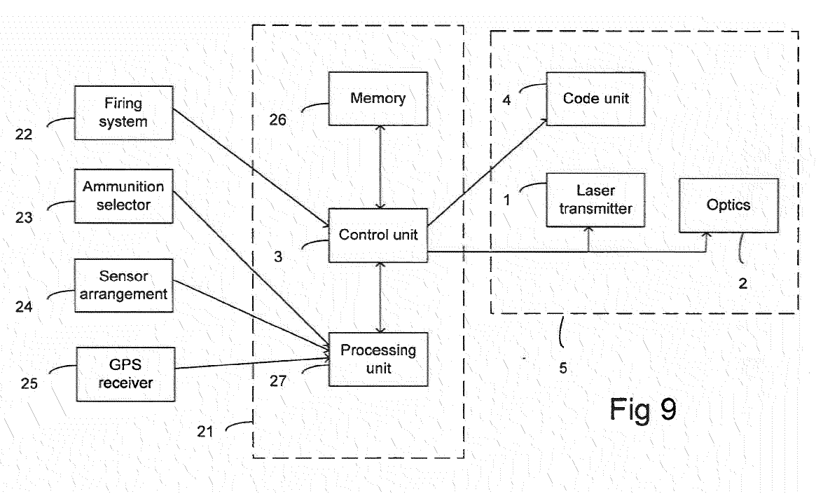

As the time t₁ at the first detector 8 is known, and as the time t₂ at the third detector 7 is known and the distance between the first 8 and the third detector 7 is known, and as the radial speed of the scanning and the distance d between the shooting system and the target system 6 is known, it is also known how the target system is oriented related to the plane perpendicular to the light lobe. Based on that, it is possible to calculate what the first detected solid angle α_{3cal} at the third detector 7 would have been if the target system was placed in a plane perpendicular to the light beam. Thereby a radial distance aᵣ between the first 8 and third detector 7 can be calculated (see FIG. 9).

The distance b between the first 8 and second 9 detector in the plane perpendicular to the light lobe is affected by the vertical orientation of the target object but does not need to be compensated for as long as the second detector only is needed as a discriminator for the ambiguity. If the vertical orientation is to be compensated for, it is possible to recalculate the received solid angle in the same manner as was performed with the horizontal compensation described above.

In FIG. 4, the letter d indicates the distance between the transmitting system 5 and the target system 6. The distance d is known to the processing unit 19. It does not constitute part of this invention how the processing unit retrieves such distance information. In a simple solution both the transmitting system 5 and the target system 6 is provided with a GPS-receiver. The coordinates for the transmitting system 5 is then transmitted to the target system for example encoded in the laser lobe or via a radio network.

Based on knowledge of the distance d and the orientation of the target object defined by the actual radial distance a, a centre 20 of the light lobe 15 can be calculated. In an example wherein the light lobe is circular shaped, a radius can be drawn around each detector i, said radius being described with the formula rᵢ=d*sin(αᵢ/2), where αᵢ is the solid angle encoded on the loser lobe that is received by detector i, in the plane perpendicular to the light lobe, ie the distance between the first and third detector is aₓ, the distance between the first and second detector is b (if the effect of the vertical orientation of the target system 6 has not been compensated for) and the distance between the first and fourth detector is cₓ. The core of the laser lobe is to be found somewhere along the radius rᵢ. In FIG. 7, the radius of the first detector 8 intersects the radius of the third detector 7 in two points. Therefore information from the second detector 97 is required only in order to choose the correct one of the two intersecting points. The intersecting point can for example be calculated using the following procedure.

Let two circles of radii R and r and centered at (0,0) and (d,0) intersect in a region shaped like an asymmetric lens. The equations of the two circles are

x²+y²=R² (1)

(x−d)²+y²=r². (2)

where x and y are the intersecting coordinates, R is the radius of the circle centered at (0,0) and r is the radius of the circle centered at (d,0)

Combining (1) and (2) gives

(x−d)²+(R²−x²)=r². (3)

Solving for x results in

$$x = \frac{{d}^{2} - {r}^{2} + {R}^{2}}{2 d} . \qquad ( 4 )$$

The chord connecting the cusps of the lens therefore has half-length y given by plugging x back in to obtain

$$\begin{matrix}{y}^{2} = {R}^{2} - {x}^{2} = {R}^{2} - {( \frac{{d}^{2} - {r}^{2} + {R}^{2}}{2 d} )}^{2} \\ = \frac{4 {d}^{2} {R}^{2} - {( {d}^{2} - {r}^{2} + {R}^{2} )}^{2}}{4 {d}^{2}} .\end{matrix} \qquad \begin{matrix}( 5 ) \\ ( 6 )\end{matrix}$$

Now by inserting the known figures of R, r and d the intersecting coordinates x and y can be determined.

To compensate for not perpendicular shoot angle just replace the d above with 2*D*tan(Vrad*(t2−t1)/2) where D is the distance between the transmitting system and the target system and Vrad is the radial speed of the light lobe scanning.

By knowing these intersecting coordinates in relation to the physical position of the detectors and the physical position of the detectors on the target the processing unit can with high precision determine the hit position on the target or if the coordinates are outside the target determine how far and where the simulated ammunition passed the target. This is very useful in gunnery training.

The processing unit of the target could have a target template divided in different physical zones defined by a specific vulnerability. This is useful for example when the target is a vehicle. It could have a low zone with vulnerability “mobility kill” and a high zone with vulnerability “kill”. A hit position within the low zone could then yield in a simulated immobilized vehicle (the crew still alive though) while a hit in the upper zone could yield in a situation where the crew is “killed” and the vehicle is immobilized.

The precision of the innovation provides use of more and smaller vulnerability zones enabling even more realistic training.

The radius around the second detector 9 is only used for determining which one of the two intersecting points between the radius around the first and the third detectors relates to the position of the core of the light beam.

In accordance with a first application of the invention, the transmitting system 5 and target system 6 is used in a navigation application, such as a landing aid for flying vehicles or in an application wherein vehicles are intended to follow a leading vehicle. In the navigation application, each vehicle is provided with the target system and arranged to navigate towards the centre of the lobe. In the landing aid application, the transmitting system is for example mounted at a runway. In this application a vehicle path calculator unit (not shown) can be arranged to calculate an optimal path for the flying vehicle going in for landing. Accordingly, the light lobe is coded with information indicating how the landing path should diverge from the centre of the light lobe, by means of a distance value and an angle value which are continuously updated. In the application wherein vehicles are intended to follow a leading vehicle, the transmitting system is in one example mounted at the back of the leading vehicle and the following vehicle(s) is (are) arranged to follow the centre of the light lobe.

In accordance with a second application, the transmitting system 5 and target system 6 constitute part of an IFF system (Identification Friend or Foe). The transmitting system 5 is then for example mounted on a conventional weapon, such as a hand gun, a gun mounted on a tank etc, or on a virtual weapon. The light lobe 15 is in this application encoded with an inquiry message in addition to the solid angle information. The inquiry message is processed by the target system 6 and a correct reply is formed by the target system if the target system is in the possession of a correct key, which is the case when the target system is a friend. The determined distance to the centre of the light beam determines a priority for replying to the inquiry message. When the target system is determined to be close to the centre of the beam, responding to the inquiry has a high priority while the priority for responding to the inquiry is lower when the target system is located at a longer distance from the centre of the lobe.

The light source is in accordance with a third embodiment of the invention included in a shooting simulator for firing practice. The shooting simulator can be mounted on a conventional weapon, such as a hand gun, a gun mounted on a tank etc, or on a virtual weapon. The target systems 6 are then mounted on potential target objects such as vehicles, soldiers etc. In accordance with this application, the centre of the light beam approximates the trajectory of simulated ammunition. The processing unit is in accordance with this application arranged to perform hit evaluation based on how the centre of the beam is related to the target object. If the centre of the light beam is determined to hit directly at the target system, the probability of being killed/injured/damaged is high while the probability of being killed/injured/damaged is low if the centre of the beam falls outside the target object. In this application it is advantageous if identity information for the shooting system and potentially also a code related to the type of ammunition is encoded into the light lobe.

In an extended version of the shooting simulator application in FIG. 9, the simulation system comprises the transmitting system 5 disposed in connection with the gun, suitably in the barrel of the gun, and a simulator unit 21. The simulator unit 21 is connected with a firing system 22 for the gun, an ammunition selector 23 for selecting the ammunition type, a sensor arrangement 24 to determine, among other things, the motion status of the weapon, and a GPS receiver 25 that receives the geographical position of the simulator unit 21. According to one embodiment, the GPS receiver is supplemented with a radio receiver for receiving a correcting signal, so-called DGPS.

The weapon is aimed and fired as though a real round were being fired, and each time the gunner fires the weapon, the simulator unit 21 is activated. The simulator unit 21 contains a memory 26 arranged so as to store an identity that is unique for the weapon. The target objects also each have a unique identity stored in a memory belonging to each respective target. The weapon constantly receives geographical position information via the GPS receiver 25. The target objects also possess knowledge regarding their current geographical positions via a GPS receiver, or DGPS receivers, disposed at each respective target.

An imagined trajectory of an ammunition is generated in that, upon firing of the weapon, a processing unit 27 that works together with the control unit 3 is initiated to generate a signal that reproduces the trajectory of the ammunition, taking into account such factors as will affect the trajectory before, after and at the instant of firing. Factors that are of interest before firing include the type of ammunition, which is selected in view of the target to be attacked. In the illustrative example, the gunner indicates the selected ammunition type by setting the ammunition selector 23, which is operatively connected with the processing unit 27. Other factors that affect the ammunition trajectory are the alignment of the weapon and its motion status at the instant of firing. These parameters are supplied from the sensor arrangement 24, which is operatively connected with the processing unit 27. For example, the sensor arrangement 24 is equipped with a gyro by means of which the motion status of the weapon is detected. The processing unit 27 generates a signal that is determined relative to the gun and represents the imagined ammunition trajectory.

The processing unit 27 is arranged to continuously determine the coordinates of the ammunition in a predetermined reference system. In one example the reference system has its origin of coordinates in the shooting system and in another example the coordinates are given in longitude and latitude.

In one example, the processing unit 27 is arranged so as to calculate the ammunition trajectory in real time, whereupon the most recently calculated value is related to the centre of the beam transmitted to the code unit for inclusion in the laser lobe. Alternatively, the entire ammunition trajectory is calculated upon the firing of a simulated round, whereupon the values at the calculation points are related to the centre of the laser lobe and outputted in real time. The momentary ammunition coordinate could be represented as a radius and an angle counted from the gravity direction.

The control unit 3 is arranged to feed the information regarding the perpendicular distance to the centre of the light lobe along with solid angle information is converted into series of pulses and pauses by means of which the lobes of the laser transmitter are modulated in a manner that is known per se. The information is received by the target objects and hit evaluation is performed based on the current position of the ammunition retrieved from the coordinates for the centre of the light beam and the information regarding the distance between the radial ammunition and the light beam.

In a simple embodiment of the invention, herein described related to the shooting simulator application, the light source has two fixed solid angles. When transmitting the light beam with the first fixed solid angle, narrower than the second solid angle, the lobe is coded with information defining a kill code. When, on the other hand, transmitting the light lobe with the second fixed solid angle, broader than the first solid angle, the beam is coded with information defining a near miss code. In another simple embodiment, the light source has three or more discrete solid angles, each related to a corresponding information. For example, the first fixed solid angle is associated to a kill code, and the second, third and so on fixed solid angle each is related to a probability of kill and a probability of injure wherein the probability of kill and injury is decreased with increased solid angle.

The simple embodiment with two fixed solid angles can also be used for example in the IFF application wherein the narrower solid angles imply higher priority in replying and broader solid angles imply lower reply priority.

In one example, the light lobe has a fixed width (Saab SAT lobe type) substantially along its entire range. In accordance with this embodiment, the absolute distance to the centre of the lobe is the same substantially for all distances and thus distance between the detector detecting the lobe and the center of the lobe can be determined in a simplified manner without having to take regard to the distance between the shooting system and the target system.

In the examples described above, the light lobe can be solid or hollow. In the case of a solid light beam, the first beam incident on each detector is detected and processed and the light beams incident thereafter are discarded until a new radial sweep is commenced. In the case of a hollow light lobe, the detectors only detect incident light when it is to be processed.

The light lobe can be circular, constitute part of a circle, etc. In the case wherein the light lobe only constitutes part of a circle, the core of the light lobe can be determined using only two detectors.

1. A device arranged to illuminate an area, comprising:
a light source arranged to transmit a light lobe said light lobe being coded with information and having a predetermined solid angle defining the width of the light lobe, wherein the light lobe is expandable/compressible between a first mode in which the light lobe has a first predetermined solid angle and a second mode in which the light lobe has a second predetermined solid angle, and wherein the light lobe is arranged to carry first information in the first mode and second information in the second mode.

2. The device according to claim 1, wherein the light source is arranged to transmit the light lobe with a number of selectable solid angles within an interval between the first predetermined solid angle and the second predetermined solid angle, each selectable solid angle being associated to corresponding information.

3. The device according to claim 2, wherein the information is related to the current solid angle.

4. The device according to claim 1, wherein the light source is arranged to substantially continuously expand/compress the light lobe between the first and second solid angle, and wherein the light lobe is continuously coded with information related to the current solid angle.

5. The device according to claim 1, wherein the light lobe is hollow.

6. The device according to claim 1, wherein the light source comprises a laser transmitter.

7. The device according to claim 1, further comprising:
an optical arrangement arranged in the beam path after the light source, which optical arrangement is arranged to form a selected solid angle among at least the first predetermined solid angle and the second predetermined solid angle.

8. The device according to claim 1, wherein an output power of the light source is adaptive as a function of the solid angle.

9. The device device according to claim 1, further comprising:
a forming element configured to form the light lobe so as to provide an essentially constant lobe width substantially along the entire range of the light lobe.

10. A shooting simulator, comprising:
a device comprising a light source arranged to transmit a light lobe said light lobe being coded with information and having a predetermined solid angle defining the width of the light lobe, wherein the light lobe is expandable/compressible between a first mode in which the light lobe has a first predetermined solid angle and a second mode in which the light lobe has a second predetermined solid angle, and wherein the light lobe is arranged to carry first information in the first mode and second information in the second mode.

11. The shooting simulator according to claim 10, wherein the second solid angle is larger than the first solid angle, and wherein the first information contains hit information and the second information contains near miss information.

12. A system, comprising:
a device, comprising a light source arranged to transmit a light lobe said light lobe being coded with information and having a predetermined solid angle defining the width of the light lobe, wherein the light lobe is expandable/compressible between a first mode in which the light lobe has a first predetermined solid angle and a second mode in which the light lobe has a second predetermined solid angle, and wherein the light lobe is arranged to carry first information in the first mode and second information in the second mode, said device being arranged to illuminate an area and comprising a light source arranged to transmit a light lobe, and one or more objects present within said area and, each object being provided with a target system arranged to detect said light lobe.

13. The system according to claim 12, wherein each target system is arranged to determine a center of said light lobe.

14. The system according to claim 13, wherein each target system comprises at least one detector arranged to detect incident light and a processing unit arranged to receive the information coded in the detected light and to determine an angular distance to the center of the lobe based on angle information coded in the detected light.

15. An alignment system, comprising:
a device comprising a light source arranged to transmit a light lobe said light lobe being coded with information and having a predetermined solid angle defining the width of the light lobe, wherein the light lobe is expandable/compressible between a first mode in which the light lobe has a first predetermined solid angle and a second mode in which the light lobe has a second predetermined solid angle, and wherein the light lobe is arranged to carry first information in the first mode and second information in the second mode, and
a detector arrangement arranged at a known distance from the device, said detector arrangement being arranged to feed the information coded the incident light to a processing unit arranged to determine the alignment of the device.

16. The device according to claim 1, further comprising:
an identification friend foe system.

17. The device according to claim 1, further comprising:
a navigation system.

18. The device according to claim 17, wherein the navigation system comprises a landing system for flying vehicles.
